(19) United States
(12) Patent Application Publication
(10) Pub. No.: US 2025/0158710 A1
(43) Pub. Date: May 15, 2025

(54) LIGHT BASED COMMUNICATIONS

(71) Applicant: Radiant Research Limited, Oldbury (GB)

(72) Inventors: Geoffrey Archenhold, Oldbury (GB); Navid Hassan, Oldury (GB); Martin Harris, Oldbury (GB)

(73) Assignee: Radiant Research Limited, Oldbury (GB)

(21) Appl. No.: 19/023,915

(22) Filed: Jan. 16, 2025

Related U.S. Application Data
(63) Continuation of application No. PCT/GB2023/051739, filed on Jul. 3, 2023.

(30) Foreign Application Priority Data
Jul. 19, 2022 (GB) 2210541.5

(51) Int. Cl. H04B 10/116

(52) U.S. Cl. CPC H04B 10/116

(57) ABSTRACT

A method of decoding a detected light signal (19) to extract data transmitted via light based communications, the method comprising: receiving a detected light signal (19) having a plurality of signal features (23) corresponding to bits of at least part of a transmitted data packet (500); identifying a location of at least one first region of the detected signal (19) corresponding to a header (25) of a data packet (500); identifying a location of at least one second region of the detected signal corresponding to a payload (27) of the data packet (500), based on the position of the at least one first region; and decoding the signal features (23) in the at least one second region to derive a string of data.

### CROSS-REFERENCE TO RELATED APPLICATIONS

This application is a continuation of PCT Application No. PCT/GB2023/051739, filed on Jul. 3, 2023 and titled: LIGHT BASED COMMUNICATIONS, which claims the benefit of GB Patent Application Serial No. 2210541.5 filed on Jul. 19, 2022.

### TECHNICAL FIELD

The present disclosure relates to a method of decoding data in light based communications a lighting system, a device for light based communications. The present disclosure also relates to an apparatus for performing the method of determining a position of a device, devices that can be positioned according to a method, a lighting system that may be used to determine the position of a device, and a system made up of the lighting system and devices.

### BACKGROUND

Camera and light detectors are now found in a large number of devices. The ubiquity of such devices, and modern lighting systems which allow for fine control over lighting output provide a possible route for data communications with large numbers of people.

In an outdoor environment, a mobile device, such as a mobile phone, can be accurately positioned using a variety of different techniques. For example, a number of different Global Navigation Satellite Systems (GNSS) are known, such as the Global Positioning System (GPS), the Galileo system, the BeiDou Navigation Satellite System (BDS), and the Global Navigation Satellite System (GLOSNAS). However, these systems are not able to provide accurate positioning when the user is indoors or under a cover or roof, or when a GNSS network is not available.

Current indoor positioning systems such as positioning based on Bluetooth or WiFi beacons are based on radio waves which lead to either a high power consumption or a low accuracy. Furthermore, positioning based on beacons may require a user to login or register with a beacon, which may result in personal information being retained by third parties operating the beacons.

There is therefore a need for efficient communication using light fixtures and camera, and also for more accurate indoor with low power consumption, when a device is indoors, or GNSS is not available.

### SUMMARY

According to a first aspect of the invention, there is provided a method of decoding a detected light signal to extract data transmitted via light based communications, the method comprising: receiving a detected light signal having a plurality of signal features corresponding to bits of at least part of a transmitted data packet; identifying a location of at least one first region of the detected signal corresponding to a header of a data packet; identifying a location of at least one second region of the detected signal corresponding to a payload of the data packet, based on the position of the at least one first region; and decoding the signal features in the at least one second region to derive a string of data.

The detected light signal may be light from an artificial light source intended for illumination of an area. The signal features may be encoded as modulations on a light output of the artificial light source. The modulations may not be perceptible to a user.

At least two first regions corresponding to headers of the data packet may be identified. A second region may be identified as the portion of the signal between two first regions.

Alternatively, a single header region may be identified in detected signal. The method may further comprise: identifying a first portion of the payload before the header; identifying a second portion of the payload after the header; constructing the data packet by combining the first and second portions of the payload, based on an overlap of the first and second portions.

The method may comprise: receiving a sequence of detected signals; identifying a plurality of portions of the payload before and after the header, over the sequence of detected signals; constructing the data packet by combining at least two portions of the payload from different frames or windows, based on an overlap of the at least two portions.

The detected signal may be detected in a capture window. The length of the capture window may be less than the period of the pulse used to modulate the data onto the light signal.

Identifying the location of the at least one first region of the detected signal may comprise: generating a predicted version of the header; and correlating the detected signal with the predicted version of the header. The at least one first region may be identified as a region with high correlation.

The predicted version of the header may be generated using a sampling rate of a detector that has detected the signal and a known structure of the header.

The sampling rate may be retrieved from a memory.

The sampling rate may be estimated based on a known number of bits in the header and the measured width of a feature estimated to be the header in the detected signal.

The feature estimated to be the header may be determined by applying a zero-crossing algorithm to the detected signal to identify all edges in the signal; and estimating a feature to be the header based on the known structure of the header and the identified edges.

The method may comprise determining a coarse position of the header by performing a correlation using the predicted version of the header and the detected signal.

The method may comprise: determining a fine position of the header by performing a correlation using an upsampled version of the detected signal and the predicted version of the header.

The step of determining a fine position may only be performed in the vicinity of positions in regions identified in the step of determining a coarse position.

The detected light signal may include a plurality of channels. The method may comprise: selecting only a single channel to use as the detected signal.

The method may comprise: analysing the brightness of the detected signal; and applying a gamma correction based on the analysis.

The method may comprise: analysing the detected signal for the presence of encoded data; if encoded data is present, continuing the method; and if encoded data is not present, stopping the method.

If encoded data is not present, the method may be stopped until an event indicative of a change is detected.

The event indicative of a change may be a movement of a device including a detector that has detected the signal is included.

The detected signal may be captured by a photosensitive device. The data may be modulated as different intensity levels on the signal. The photosensitive device may be a camera, and the modulations may be visible as light and dark stripes overlaying an image captured by the camera.

The detected signal may include light from at least two sources, there being interference between the output of the light sources. The data may be encoded using an orthogonal encoding system. The orthogonal encoding system may be selected from at least: code divisional multiple access, CDMA; orthogonal frequency-division multiple, OFDM; orthogonal frequency-division multiple access, OFDMA; wavelength division multiple access, WDMA; carrier-sense multiple access with collision avoidance, CSMA/CA; ALOHA; slotted ALOHA; reservation ALOHA; R-ALOHA; mobile slotted ALOHA, MS-ALOHA; or any other orthogonal encoding system.

Spatial division multiple access, SDMA, decoding may be used in combination with CDMA to determine the position of the device based on the detection of reflections of multiple light sources.

The data may comprise a unique identifier of a light source emitting the light captured in the detected signal. The method may further comprise: receiving position data indicating a location of the light source in a global co-ordinate system; and determining a position of the device, wherein the determination of the position is based, at least in part on, the position data of the artificial light source.

According to a second aspect of the invention, there is provided a lightning system comprising: one or more light sources; one or more drivers, the one or more drivers arranged to modulate the output of the light sources to encode data on the output of the light source as light based communications, the data including a data packet having a header of known structure, and a payload.

The output from at least some of the light sources may overlap. The data may be encoded using an orthogonal encoding system. The one or more drivers may be arranged to synchronise the output of the light sources.

The period of the pulse used to modulate the data onto the light emitted by the source may be longer than a window in which the data is captured.

The modulation depth of the data may be variable in dependence on the total light output.

According to a third aspect of the invention, there is provided a computer program that, when read by a computer, causes performance of the method of the first aspect.

According to a fourth aspect of the invention, there is provided a device including a detector arranged to capture a light signal for light based communications, wherein the device is arranged to perform at least part of the method of the first method.

According to a fifth aspect of the invention, there is provided a method of determining a position of a device, the method comprising: receiving data corresponding to light detected by a light sensor of the device from an artificial light source; processing the received data to extract a unique identifier of the artificial light source, the unique identifier encoded in the light; receiving position data indicating a location of the artificial light source in a global co-ordinate system; and determining a position of the device, wherein the determination of the position is based, at least in part on, the position data of the artificial light source.

Determining the position of the device may comprise: determining a relative bearing between the artificial light source and the device; and determining the position of the device based on at least the relative bearing and the location of the artificial light source in the global co-ordinate system. Determining the position of the device may comprise: determining the position based on the relative bearing between the artificial light source and the device and the bearing of the device in the global co-ordinate system.

The light sensor may be a camera and the light detected by the sensor may be an image or frame of a moving image. Determining a relative bearing may comprise: analysing an image captured by the camera to identify a location of the light source in the image or frame; and determining the bearing based on the location of the light source in the image, and an orientation of the mobile device as it captures the image.

The device may comprise two or more sensors arranged at known different angles with respect to each other. Determining a relative bearing may comprise: analysing the relative signal strength of the light received at the two or more sensors to determine the relative bearing.

The method may comprise mapping the relative bearing to a frame in which the pitch, roll and yaw of the device is 0.

Determining the position of the device may further comprise: refining the position along the relative bearing based on further information detected by the device.

The further information may comprise: a bearing from a second light source having a second unique identifier and known location in the global co-ordinate system. The further information may comprise: a bearing of the device in the global positioning system, determined by a magnetometer of the device. The further information may comprise one or more of: a relative bearing to a landmark identified by image analysis and have a known location in the global co-ordinate system; dead reckoning measured from a previous known location; or detection of signals from beacons having known locations.

The method may comprise: detecting of a light source having an encoded unique identifier is present in the field of view of the camera; if a light source is detected, determining a position of a device using the position data of the artificial light source; and if no light source is detected, turning the camera off. If no light source is detected, the camera may be turned off until movement of the device is detected by the device. If no light source is detected, the position of the device may be determined using one or more of: a relative bearing to a landmark identified by image analysis and have a known location in the global co-ordinate system; dead reckoning measured from a previous known location; or detection of signals from beacons having known locations.

The device may detect light from two different sources encoding unique identifiers, there being interference between the output of the light sources. The unique identifiers may be encoded using an orthogonal encoding system. The transmission of the unique identifiers by the two light sources may be synchronised. The orthogonal encoding system may be selected from at least: code divisional multiple access, CDMA; orthogonal frequency-division multiple, OFDM; orthogonal frequency-division multiple access, OFDMA; wavelength division multiple access, WDMA; carrier-sense multiple access with collision avoidance, CSMA/CA; ALOHA; slotted ALOHA; reservation ALOHA; R-ALOHA; mobile slotted ALOHA, MS-ALOHA; or any other orthogonal encoding system.

Spatial division multiple access, SDMA, decoding may be used in combination with CDMA to determine the position of the device based on the detection of reflections of multiple light sources.

According to a sixth aspect of the invention, there is provided an apparatus arranged to position a device according to the method of the fifth aspect.

According to a seventh aspect of the invention, there is provided a mobile phone including a camera, wherein the position of the mobile phone is determined according to the method of any of the fifth aspect, wherein the data corresponding to light detected by a light sensor of the device is one or more images captured by the camera.

According to an eight aspect of the invention, there is provided a computer program that, when read by a computer, causes performance of the method of the fifth aspect.

According to a ninth aspect of the invention, there is provided a device comprising a body having a plurality of surfaces arranged at predefined angles with respect to each other; an accelerometer arranged to detect an orientation of the device; a light sensor on each of at least two of the surfaces; and a control system arranged to cause determination of the position of the device according to the method of the fifth aspect, using the signals detected by the light sensors.

At least one of the light sensors may comprise a solar panel that also provides power to the device.

The device may further comprise: a communications interface arranged to detect ambient signals from beacons, the ambient signals used to determine the position of the device.

According to a tenth aspect of the invention, there is provided a lighting system including: one or more light sources, wherein at least some of the light sources have a unique identifier; one or more drivers, the one or more drivers arranged to modulate the output of the light sources having unique identifiers to encode the unique identifier on the output of the light source as light based communications; and a database associating the unique identifier of each light source with a position of each light source, such that devices detecting light from a particular light source and decoding the unique identifier can be located using the position of the particular light source.

The output from at least some of the light sources having unique identifiers may overlap. The unique identifiers may be encoded using an orthogonal encoding system. The one or more drivers may be arranged to synchronise the output of the light sources.

According to an eleventh aspect of the invention, there is provided a system including a lighting system of the tenth aspect; and one or more devices having a light sensor arranged to detect light from the light source of the lighting system. The position of the devices may be determined according to the method of the fifth aspect.

According to a further aspect of the invention, there is provided a method of determining a position of a device, the method comprising: receiving data corresponding to light transmitted by the device; processing data to extract a unique identifier of the device, the unique identifier encoded in the light; receiving position data indicating a location of the sensor at which the light was detected; and determining a location of the device based, at least in part on, the position data.

According to yet a further aspect of the invention, there is provided a structure having a lighting system fitted to enable positioning within the structure using the methods discussed above. The method may further comprise guiding a user to a nearest exit. The method may comprise providing directions to the nearest exit on the device. The structure may be a tunnel or building.

According to another aspect of the invention, there is provided a lighting system for light based communications, the system comprising: one or more light sources arranged to transmit data as modulations on the output of the light source, wherein the different light sources may transmit different data, the data encoded using an orthogonal encoding system. For example, the orthogonal encoding system may be selected from at least: code division multiple access encoding (CDMA); orthogonal frequency-division multiple, OFDM; orthogonal frequency-division multiple access, OFDMA; wavelength division multiple access, WDMA; carrier-sense multiple access with collision avoidance, CSMA/CA; ALOHA; slotted ALOHA; reservation ALOHA; R-ALOHA; mobile slotted ALOHA, MS-ALOHA; or any other orthogonal encoding system.

Features discussed in relation to any particular aspect may be applied, mutatis mutandis, to any other aspect, unless mutually exclusive.

Aspect of the invention provide a quick and simple way of achieving visible light based communications (VLC) in real time, in an efficient way with low power consumption. The algorithm used means the data packets can often be extracted and decoded in less than 30 ms. Furthermore, no specialist equipment is required at least at the receiver (camera/detector end), since the methods can be implemented entirely in software.

Positioning of a device based on VLC such as discussed is low-power consumption and high accuracy, achieving up to sub-10-cm accuracy. Due to the simplicity of the algorithms employed, the processing time to determine the position is often between 30 ms and 100 ms, and is sometimes less than 30 ms. Therefore a position can be occurred in real time for users.

In embodiments where a camera is used to determine the position using VLC, referred to as optical camera communications (OCC) an accuracy of up to 1 cm can be achieved. Furthermore, a rolling shutter based OCC can be employed to determine the unique identifier of the light source, providing higher rate of data transfer and mitigating flickering. The short processing time means that OCC-based methods can be implemented using mobile phone cameras having a frame rate of 30 fps.

The ability to provide real time VLC and/or locate a device and user indoors with up to 1 cm resolution in all dimensions provides the ability to create the next generation of location-based services and other types of service. For example VLC (including but not limited to OCC) can be used for the following:
In restaurants and cafes, it enables ordering food and beverages with the vendor automatically knowing which table the customer is sitting at, at the time of ordering. If the client move tables, their position can be updated, automatically;
Further services may be triggered based on a detected location or information provided via VLC. This may include marketing services, provision of vouchers or coupons, provision of information about a product or item (for example in a museum);
User authentication or registration at a location may be initiated and completed based on the determined location;
Triggering door access or access to restricted areas;
Tracking the position of individual users, such as patients in a hospital;
Providing guidance to users to a destination. In one such case, a user may be guided to a closest exit in an emergency;
Asset tracking—in some cases purpose made beacons may be fitted to objects to track the objects—for example in warehouses or hospitals; and
Augmented reality and virtual reality application, such as Metaverse solutions.

It will be appreciated that the above are given by way of example only, and there are many potential applications which require precision positioning at specific moments in time and which may benefit from the above methods and devices.

### BRIEF DESCRIPTION OF THE DRAWINGS

Embodiments of the invention will now be described, by way of example only, to the drawings, in which:

FIG. 1A illustrates a system for positioning a device using visible light based communications (VLC) in plan view;

FIG. 1B illustrates the system of FIG. 1A in side on view;

FIG. 2 illustrates an example of an image captured by a camera in the system of FIG. 1A, showing a unique identifier of a light source transmitted using VLC;

FIG. 3 schematically illustrates a system for determining a device in the system of FIG. 1A;

FIG. 4 shows a flow chart of the method for extracting a unique identifier from the image of FIG. 2;

FIG. 5 shows a flow chart of the method for determining the location of the data packet header in the image of FIG. 2;

FIG. 6 shows a flow chart of estimating the sampling rate of the camera using the image of FIG. 2;

FIG. 7 shows a flow chart of the method for determining the position of a device in the system of FIG. 1, using VLC;

FIG. 8 shows a flow chart of the method for determining the relative bearing between the device and the light source;

FIG. 9A schematically illustrates an image of a light source captured during the method of FIG. 8;

FIG. 9B schematically illustrates the arrangement of the light source and device during the method of FIG. 8 in plan view;

FIG. 9C schematically illustrates the arrangement of the light source and device during the method of FIG. 8 in side view;

FIG. 9D illustrates the transformations of pitch, roll and yaw angle in the method of FIG. 8;

FIG. 10 schematically illustrates a lighting system used in VLC positioning;

FIG. 11A illustrates the arrangement of a system for positioning a device based on the reflection of two light sources, in side view;

FIG. 11B illustrates the arrangement of a system for positioning a device based on the reflection of two light sources, in plan view;

FIG. 12 schematically illustrates a VLC data packet;

FIG. 13A illustrates a tag that can be located using VLC positioning, in perspective view; and

FIG. 13B illustrates the tag of FIG. 13A in cut-through side view.

### DETAILED DESCRIPTION

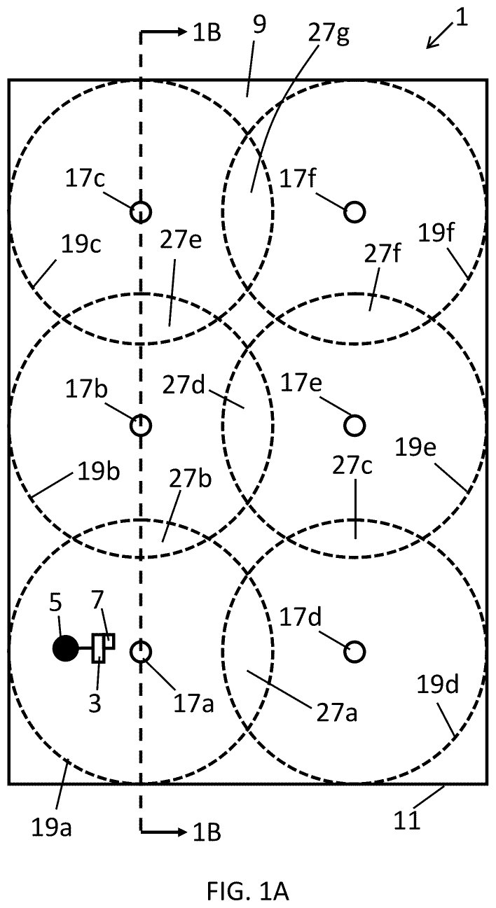

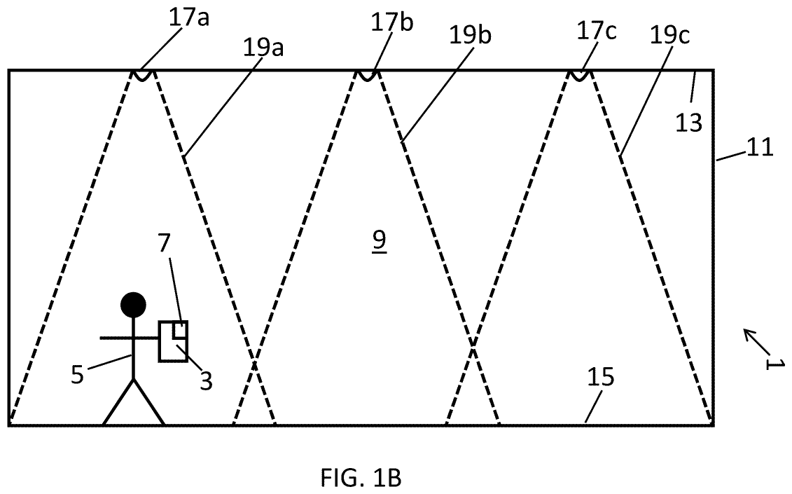

FIGS. 1A and 1B schematically illustrate part of a system 1 including a device 3 which is to be positioned in a global position frame (such as a GNSS frame). FIG. 1A shows the system 1 in plan view and FIG. 1B shows the system 1 in side on view.

In the below description, the device 3 is assumed to be a mobile phone of a user 5, including a camera 7. However, this is by way of example only and any device having a camera of light sensor may be used.

In the example shown, the system 1 is provided in an indoor space 9 defined by walls 11, a ceiling 13 and a floor 15. The space 9 is illuminated by a number of light sources 17a-f, such as light emitting diode light fixtures fixed to the ceiling. The light source 17a-f provide artificial light to illuminate the space 9. The output each light source 17a-f is shown as footprint 19a-f, illustrated by short-dashed lines. As can be seen, there is overlap 27a-g of the output 19a-f from adjacent light sources.

In a first example, the light sources 17a-f are split into a first set of light sources 17a, 17c, 17e and a second set of light sources 17b, 17d, 17f. Each set is made up of light sources 17a-f which have non-overlapping footprint 19a-f. Thus, the footprint 19a, 19c, 19e of any of the light sources 17a, 17c, 17e in the first set does not overlap with the footprint 19a, 19c, 19e of any other light source 17a, 17c, 17e in the first set and the footprint 19b, 19d, 19f of any of the light sources 17b, 17d, 17f in the second set does not overlap with the footprint 19b, 19d, 19f of any other light source 17b, 17d, 17f in the second set. The footprint 19a-f of light source 17a-f in one of the sets may overlap with the footprint 19a-f of the light sources 17a-d in the other set.

Each of the light sources 17a, 17c, 17e in the first set is provided with a unique identifier ID1, ID2, ID3 that is encoded in the light output 19a, 19c, 19e of the light source 17a, 17c, 17e. No identifier or other information is encoded in the light output 19b, 19d, 19f of the second set of light sources 17b, 17d, 17f.

The unique identifiers ID1, ID2, ID3 are generated in the form a string of data. In one example, the string may be two bytes in length. The string is encoded into the light output 19a, 19c, 19e by a corresponding driver 43, using various coding techniques, as modulations on the intensity of the signal from the light source 17a, 17c, 17e. Compared to the amplitude and frequency of the power signal, the amplitude of the modulations is sufficiently small and the frequency sufficiently fast that the modulation is not perceptible as flicker or distortion to the user, but can be picked up by suitable sensors.

EP 2 627 155 B1, which is hereby incorporated by reference, provides one example of a power control system for a lighting system that can provide optical wireless communications in this way.

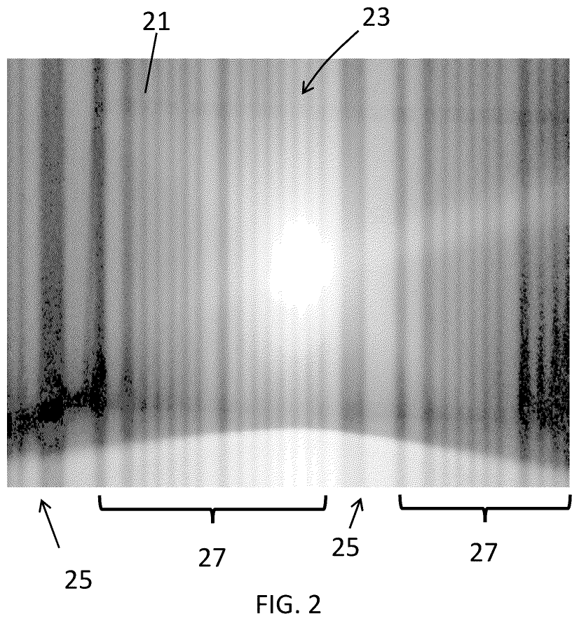

FIG. 2 illustrates an example of an image 21 of a light source 17a with as unique identifier ID1 provided by VLC. The image is captured by the camera 7 of the mobile device 3. The image 21 may be a single still image, or a frame from a moving image. The moving image may have been previously captured, or may be “live” such that the moving image is currently being captured in parallel to the processing of the image 21 to determine a position.

In order to capture the VLC modulated data, the exposure time of the camera 7 is set to less than the period of the pulse used to modulate the unique identifier ID1 onto the signal, which is a known parameter of the system. The period of the pulses may be chosen such that the unique identifier ID1 is not visible during normal operation of the camera 7. Furthermore, as will be discussed below, the camera settings are chosen such that the image is not saturated nor under-exposed.

As can be seen from FIG. 2, the unique user identifier ID1 is encoded by regions of light and dark striations 23 in the image 21. Due to the roller shutter effect shown by a CMOS camera 7, the striations created by any form of amplitude shift keying, as in this case, will always be seen along the vertical axis of the image 21.

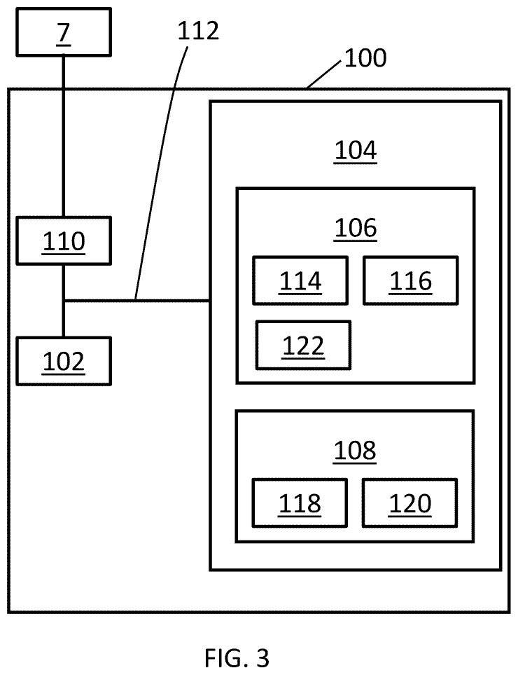

FIG. 3 schematically illustrates a processing system 100 for determining the position of the device 3. The processing system 100 first decodes the unique identifier ID1 from the captured image 21 and then determines the position of the device 3.

The processing system 100 includes a processor, controller or logic circuitry 102, a memory 104, subdivided into program storage 106 and data storage 108, and a communications interface 110, all connected to each other over a system bus 112. The communications interface 110 is further in communication with the camera 7 of the device 3.

In one example, the processing system 100 may be formed as part of the device 3, in which case the connection to the camera 7 may be a physical connection. In this case, the communications interface 110 may act as a driver for the camera 7. In other examples, the processing system 100 may be separate from the device. In this case, the image data captured by the camera 7 may be received over any suitable communications link. This may be, for example, an internet connection, a wired connection, a wireless connection such as 4G, 5G, WiFi or Bluetooth or any other suitable connection.

The program storage portion 106 of the memory 104 contains program code including instructions that when executed on the processor, controller or logic circuitry 102 instruct the processor, controller or logic circuitry 102 what steps to perform. The program code may be delivered to memory 104 in any suitable manner. For example, the program code may be installed on the device from a CDROM; a DVD ROM/RAM (including −R/−RW or +R/+RW); a separate hard drive; a memory (including a USB drive; an SD card; a compact flash card or the like); a transmitted signal (including an Internet download, ftp file transfer of the like); a wire; etc.

The processor, controller or logic circuitry 102 may be any suitable controller, for example an Intel® X86 processor such as an 15, 17, 19 processor or the like.

The memory 202 could be provided by a variety of devices. For example, the memory 104 may be provided by a cache memory, a RAM memory, a local mass storage device such as the hard disk, any of these connected to the processor, controller or logic circuitry 102 over a network connection. The processor, controller or logic circuitry 102 can access the memory 104 via the system bus 112 and, if necessary, through the communications interface 110 such as WiFi, 4G and the like, to access program storage portion 106 of the memory 104.

It will be appreciated that although the processor, controller or logic circuitry 102 and memory 104 have been described as single units, the functions of these elements may be distributed across a number of different devices or units. Furthermore, the processing steps discussed below may all be performed at the same locations or two or more different locations.

The program storage portion 106 of the memory 104 contains different modules or units that each perform a different function. For example, a first module 114 is provided to process the captured image 21 to determine the unique identifier ID1 encoded in the image 21. A second module 116 is provided to determine the position of the device 3 that captures the image 21. As such the first module 114 may be considered an identifier extraction module and the second module 116 a positioning module.

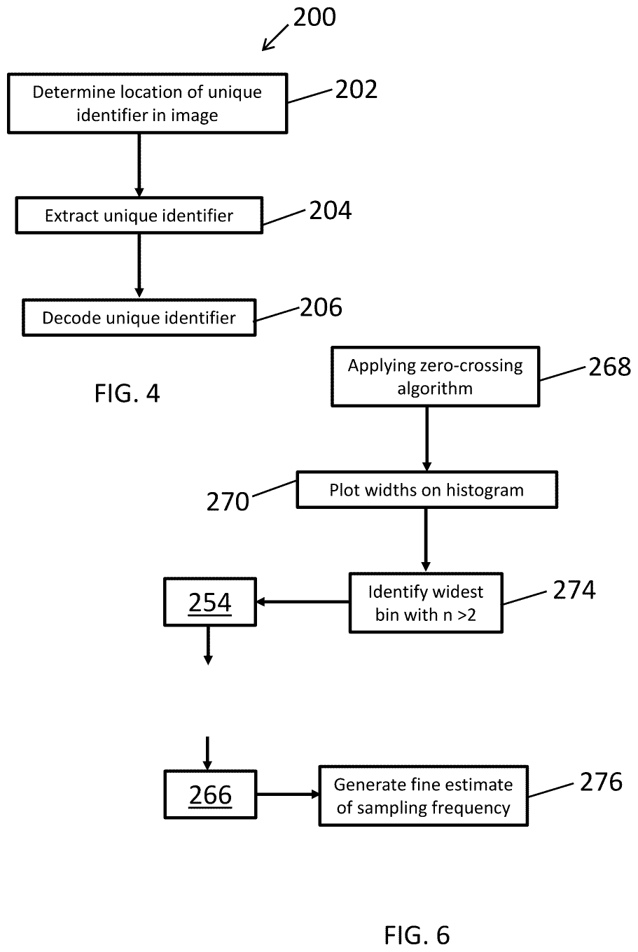

FIG. 4 schematically illustrates an example method 200 for decoding the unique identifier ID1 encoded in the image 21 of FIG. 2.

In a first step 202, the location of the unique identifier ID1 in the image 21 is determined.

In one embodiment, Manchester encoding is used to encode the unique identifier ID1 so that it can be transmitted as a pattern in the light output 19a encoding the identifier. The unique identifier ID1 of the light source 17a is generated as a series of bits having high or low value (e.g. 1 or 0). These bits may be generated from a more complex identifier using conversion tables or the like.

The bits are then combined with a clock signal to generate an encoded identifier xID1, having a series of high and low values. The encoded identifier xID1 is then modulated onto the light output 19a of the corresponding light source 17a on a loop.

Due to the rolling shutter effect, the encoded identifier xID1 appears as a series of stipes or striations in the captured image, the stripes oriented vertically with respect to the camera 7. Lighter regions in the image 21 may correspond to high values in the encoded identifier and darker regions may correspond to low values, or vice versa. As can be seen from FIG. 2, the unique identifier ID1 forms a repeating pattern over the image.

The unique identifier ID1 includes a header region 25 that indicates the start of the unique identifier ID1 and a payload region 27 which includes the encoded identifier xID1. In the example of Manchester encoding, the header region 25 is formed as the widest feature. As such, the location of the unique identifier ID1 is determined based on identification of the header region 25 of successive iterations of the unique identifier ID1. The payload region 27 (which corresponds to the unique identifier) is simply extracted as the region between two headers 25.

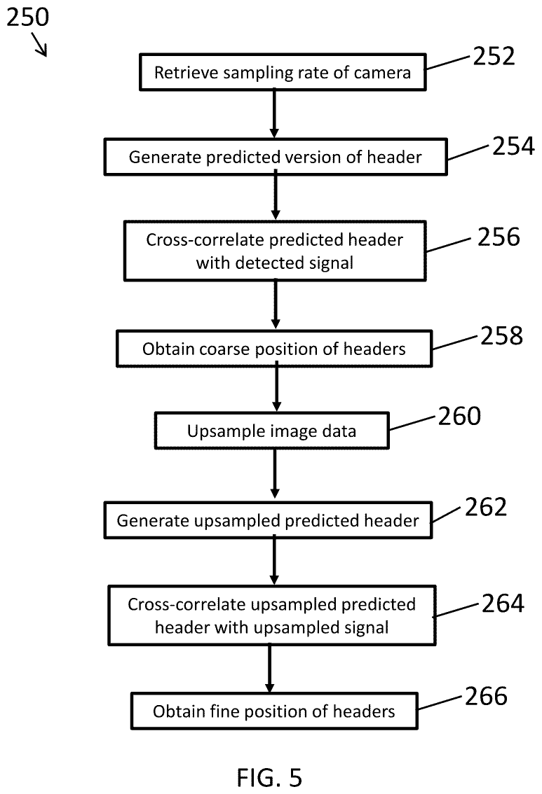

FIG. 5 illustrates a detailed method 250 of determining the location of the unique identifier ID1 and extracting the sampling rate of the camera 7. It will be appreciated that this method 250 is given by way of example only, and any suitable method may be used.

At a first step 252, the sampling rate of the camera 7 is rate is retrieved.

In one example, the sampling rate may be retrieved from the data storage portion 108 of the memory 104, for example a system parameters part 118 of the data storage portion 108 of the memory 104 may include the sampling rate, and information on the expected number of bits in the unique identifier ID1. The sampling rate may be known from production/design parameters, software operational parameters, or previous calibration. Alternatively, as will be discussed below in more detail, the sampling rate of the camera may have been determined previously by the identifier extraction module 114.

The sampling rate of the camera 7 is generally consistent throughout the lifetime of the camera 7. Therefore, once the sampling rate is known and stored, redetermination is not required. However, redetermination of the sampling rate may be required if the transmitted frequency of the VLC communications (the frequency of modulation of the VLC data) is not known or standardised.

In a second step 254, a predicted version of the header 25 is generated using the retrieved sample rate and knowledge of the header information (for example, this may be known form the known encoding method used).

In a third step 256, the predicted header is cross-correlated with the signal detected by the camera 7 (i.e. the image 21)

The cross-correlation produces a number of detected peaks which corresponded to candidate positions for the unique identifier ID1. It will be appreciated that the image 21 may include multiple headers 25 and also peaks in the correlation that do not correspond to headers.

In the current example, the header is of the form [1,1,1,1,0,0,0,0]. This causes a high peak in the correlation with a low valley around it. By subtracting the peak and the immediate next valley from the correlation output, the contrast of the correct header portions from other peaks in the correlation is increased. Therefore, in step 258, the coarse header positions are obtained.

Subsequently, a fine estimate of the header position is obtained. To do this, the image data is upsampled using linear interpolation at step 260. At step 262, an upsampled version of the header 25 is generated and then at step 264, this is cross correlated with the upsampled data around the candidate header positions identified in step 258. This allows the accurate header positions to be identified in step 266 with reduced processing complexity.

At a second step 204 of the method 200 for decoding the unique identifier ID1, the encrypted identifier xID1 is extracted from the image 21. In this step, the pattern of light and dark stripes in the payload region 27 between headers 25 is converted back to a string of high and low values (1 s or 0 s) for each bit of the string. In order to convert the stripes into the string, the width of each bit in the image is determined. The width of each bit is based on the sampling rate of the camera 7 and the known number of bits in the payload region 27.

Finally, at a third step 206, the string is decoded using Manchester decoding to determine the unique identifier ID1.

Where the sampling rate of the camera 7 is not known, the above method can be used to generate an estimate of the sampling rate. The steps required for determining the sampling rate are shown in FIG. 6.

At a first step 268, a zero-crossing algorithm or other technique to identify changes or edges in the signal output, and find widths of the stripes in the signal. Then, at step 270, the identified widths are plotted in a histogram, with each bin of the histogram corresponding to a different width between edges. As discussed above, the header is of known format having a wide area of high values and a wide area of low values, and so at step 272, the width of the header is taken from the bin with the largest width that has at least two counts in the histogram bin. From the header width, a coarse estimate of the sampling rate of the camera 7 can be obtained at step 274. This sampling rate is used as the retrieved sampling rate in step 252 of FIG. 5. The width of the narrowest bin could, alternatively, be used for determining the width of one bit in a high signal to noise ratio image. However, identifying the header to determine the width of the bit reduces inaccuracy in low signal to noise ratio situations.

After the high resolution position of the headers is determined in step 266 of FIG. 5, a fine estimate of the sampling frequency can be generated using the width between two headers in step 276. This can be stored for later use and retrieval in step 252.

In general, the above processing is performed on the raw data to enhance processing speed. However, it will be appreciated that various optional pre-processing steps may occur to enhance processing speed:
Typically, cameras capture every image in three channels of red, green, and blue. Therefore, every image is a matrix with a size of U×V×3. Channels may be selected and/or combined to reduce the dimension of the data. In one example, the green channel may be used as CMOS and other CCD sensors are most responsive in this range. In other examples, a calculation may be made to assess which channel is used (for example based on which channel best shows the unique identifier).
A calibration process may be performed on the received signal in order to remove any dependency on the scene, the shape of the objects, and the intensity of reflected light from environment. This significantly simplifies the signal processing.
The image may be checked for the brightness. Depending on the level of brightness a gamma correction is applied to the image to enhance the signal-to-noise ratio.
Prior to any image processing, a check may be performed to see if there is a light source in the field of view of the camera 7 and if the light carries VLC data. If there is no light source or no VLC data is available, then that image (which may be a single frame of a moving image) is skipped and significant amount of processing is saved.
Multiple morphological operations such as dilation and erosion may be applied to the image, along with thresholding to output a binarized image where only the bright objects will remain in the image, everything else is filtered out.
Topological analysis may be performed to find the edges of shapes, in this case, light sources 17a-f. Checks are performed to ensure the total area of each object found is above a threshold deemed to be acceptable for a light source. Where edge recognition is performed, the presence of VLC data may be analysed by looking at a subsection of the image data using the XY location and the width/height of a bounding box around identified shapes (plus a padding percentage) A summation of the column data is then performed, and a low pass filter is applied and the local minima and maxima are calculated. If there are numerous peaks there is a near guaranteed chance the image has VLC data. If there a small number of peaks found then it is most likely noise.
In order to reduce the impact of the noise on the quality of the received signal, an average over the illuminated area is taken in one dimension, for example, an average may be calculated from the cells in a single column, or the cells identified in a single bit/stripe in the image.
The received signal may be calibrated in order to enhance the robustness of the algorithm and the speed of processing. This is done by filtering the signal with a very narrowband low pass filter and normalising the original signal to the filtered signal. This also helps to mitigate the distortion in the signal due to the shape of the footprint of the light in the image.

Furthermore, the processing system 100 may control the operation of the camera 7 to ensure the unique identifier ID1 is readable by the system, and to reduce the signal to noise ratio when detecting the unique identifier. This may include overriding normal camera settings to have extreme ISO and shutter speed values, and also disabling auto compensation options such as white balance, exposure, auto focus, and anti-banding. This ensures the exposure of the camera is less than the period of the modulation pulse, and that the image is not saturated nor under-exposed. For example, the ISO may be set to a maximum allowed by the camera. This allows for images with much higher signal to noise and interference ratios and thus improving the chances of successful VLC decoding. Changing these settings also allows for various VLC modulation depths to be used in encoding the unique identifier ID1. For example, in a system with dimming, the modulation depth may be varied with light output, so that at low light levels, the modulation depth is reduced to ensure dimming is still possible.

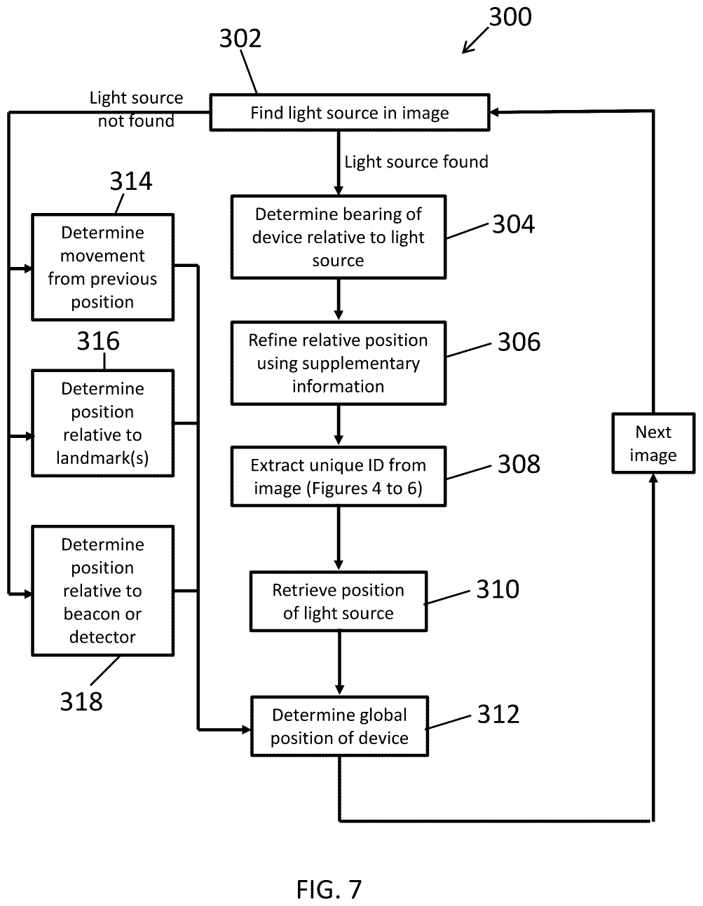

A method 300 of determining a position of a device using a light source 17a-f having a unique identifier ID1, ID2, ID3 will now be discussed with reference to FIGS. 7 to 9. The method is carried out using an image captured by the camera 7 of a mobile device 3. In this method, the stripes 23 encoding the unique identifier are stripped out of the image.

At a first step 302, the light source is identified in the image 21, and a check is made to ensure the light output encodes a unique identifier ID1, ID2, ID3. This may be the same check as the optional pre-processing step discussed above.

Where a light source 17a-f encoding an identifier is found, the method 300 proceeds to step 304. Otherwise, the method proceeds to an alternative route by one or more of steps 314, 316, 318.

At step 304, which will be discussed in more detail below, the bearing of the device 3 from the light source 17a-f is determined by analysis of the image 21. For example, an angle of departure from the light source 17a-f to the camera 7 may be determined.

In step 306, the position (x, y and optionally z) of the device 3 relative to the light source 17a-f may be refined using supplementary information.

In step 308, the unique identifier of the light source 17a-f is extracted from the image 21, using the method 200 discussed above.

In step 310, the position of the light source 17a-f is retrieved from lookup tables 120 held in the data storage portion 108 of the memory 104. The lookup tables 120 correlate the unique identifiers to positions (x_{light}, y_{light}) in a global frame of reference. Then, in step 312, the position of the device 3 in the global frame of reference (x_{global}, y_{global}) is determined according to: x_{global}=x_{light}+x, y_{global}=y_{light}+y.

As discussed above, where no light source 17a-f is identified in the image 21, the method can proceed by various other positioning methodologies, depending on the information available to mobile device 3.

In one example, various known dead reckoning positioning algorithms may be used to determine the position of the device 3 relative to a previous position in step 314. For example, this may include inertial sensors, accelerometers or other suitable sensors in the device 3 together with a step counter module 122.

The method 300 generally makes use of a camera 7 of a device 3. As such, it will likely be used when the device 3 is being held in the hand of a user. In this case, moving forward has a significant impact on the y-axis sensor, while z-axis sensor records the shocks when the foot is touching the ground. Therefore, a combination of z-axis and y-axis together with a machine learning algorithm can be employed to decide if a step is made. If a step is registered, features are extracted from the filtered signal out of the y-axis sensor and are fed it to a classifier algorithm to classify the step size in discrete classes in real time.

In another example, in step 316, the position may be determined based on other identifiable objects identified in the image 21. For example, the lookup tables 120 may include information on the position of various landmarks in an area. Various known pattern recognition algorithms may be used to identify the landmark(s) in the image 21 and then the relative position to the landmark is determined using the same technique as for determining the relative position to the light. This allows the global position of the device 3 to be determined.

In yet further examples, in step 318, the position may be based on detected or emitted signals from the device 3. According to one method, the device 3 may receive ambient signals from one or more beacons of known position. In other examples, the device 3 may emit signals detected by receivers at known positions. Various known techniques may be used to position the device relative to beacon or detector. This allows the global position of the device 3 to be determined.

Various other positioning techniques may also be used where the image 21 does not include the light source 17a-f. It will also be appreciated that the position may be determined by using a combination of one or more of the above techniques

As discussed above, in step 306, the position of the device relative to the light source 17a-f is refined using supplementary information. In the preceding step 306, the relative angle from the device 3 to the light source 17a-f is determined. This provides the position as any point on a circle around the light source 17a-f. The refining step 308 fixes the position on the circle.

In one example, a bearing of the device in the global co-ordinate system is determined, measured by a magnetometer on the device. In other examples, the position may be refined using any of the data employed in positioning steps employed when the light source is not within the image 21. For example, additional landmarks in the image 21 may be identified, or dead reckoning or signals may be used.

Alternatively, where two or more light sources 17a-f are captured in the image 21, the position may be refined using the bearings from the light sources 17a-f. This may provide a more accurate position as it does not rely on other information outside the captured images.

The method repeats iteratively, analysing a newly captured image 21′ to determine a new position of the device 3 on a regularly repeating loop.

Image processing to extract a unique identifier ID1, ID2, ID3, ID4, ID5, ID6 from one or more images/frames captured by a camera 7 typically takes between 30 ms and 100 ms, although in some examples, this may be less than 30 ms. Therefore, the determination of the position can be considered to be “real time” as it occurs in shorter timescales than a user is likely to move over, and may be less than the refresh rate of the camera 7.

It may be that as soon as the position is determined from one or more images, the method 300 reverts to the start and repeats immediately. Depending on refresh of the camera 7, this may mean that if positioning is completed using a single image/frame 21, each image/frame 21 captured is used in position determination. Alternatively, where the refresh rate is quicker than the processing time, some frames may be skipped as processing is still occurring. In other examples, it may be necessary to use multiple images/frames 21 to determine the position of the device 3.

In other cases, the method 300 may be repeated at a regular frequency selected such that not all images/frames are used. For example, the method may be selected to determine the position every 1 second, 5 seconds or the like. The regularity of determination may be varied based on, for example, a detected speed of movement of the user, the number of available light sources 17a-f and other landmarks within the vicinity of the device 3 and the like.

In some examples, where the image 21 does not include the light source 17a-f, no further images may be captured for use in locating the device 3 until the device 3 detects a movement. This may be a step or other translation, or a change in angle that may bring a light source into the image. This saves power by preventing unnecessary use of the camera.

In some cases, where movement is detected and no light source is within the field of view of the camera 7, the position may be determined by other methods, such as discussed above. Where no movement is detected by the device 3, the system may pause any determination of the position until movement is detected. Alternatively, as discussed above, the frequency of position determination may be reduced where no movement is detected.

Where the image includes the light source 17a-f, but no other information is available to refine the position, the position can still be determined to a coarse estimate, based on the area in which the light source 17a-f is visible.

It will also be appreciated that where a light source 17a-f with a VLC encoded unique ID illuminates a space, the unique identifier ID1, ID2, ID3 may be available on the image without the light source 17a-f being in the image. For example, the light may be reflected off a wall. In this case, again, a coarse estimate of the position may be obtained based on proximity to the light source corresponding to the identifier ID1, ID2, ID3. In this case the position may be further refined using the methods discussed above.

The above method provides a two dimensional position of the device (x_{global}, y_{global}). It will be appreciated that a three dimensional position may be determined based on further factors. For example, the device may include an altimeter, pressure sensor or other device that allows the height of the device to be determined.

Alternatively, the footprint of the light source 17a-f in the image may be compared to the actual size of the light source 17a-f (from lookup tables 120) to determine a scaling factor, thus allowing the height to be derived.

In further examples, such as where the resolution of the light source 17a-f in the image is not sufficient to allow the height of the device to be determined based on scaling, the speed of movement of the user based on the camera 7 and an accelerometer may be determined, and used to estimate the height.

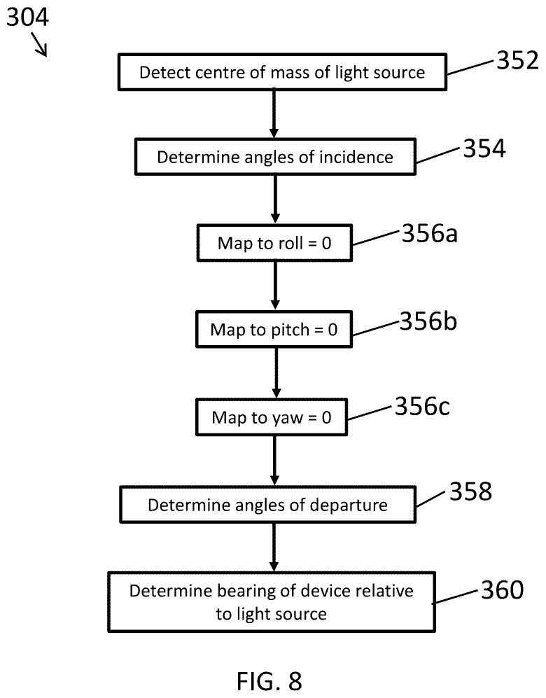

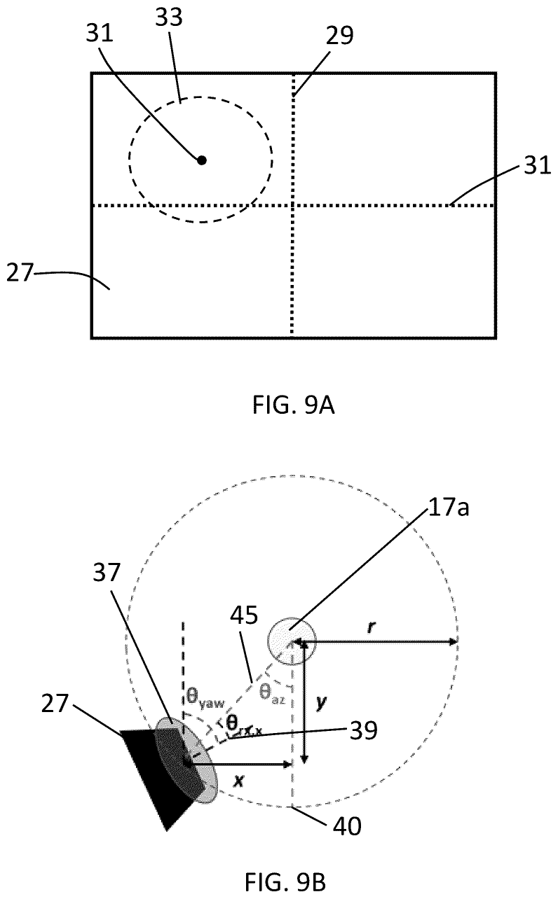

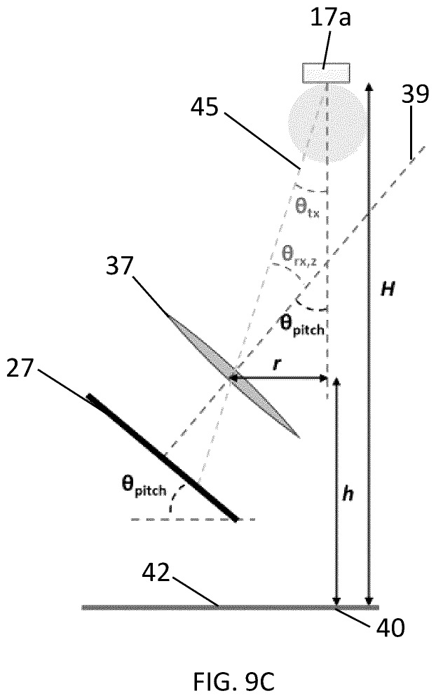

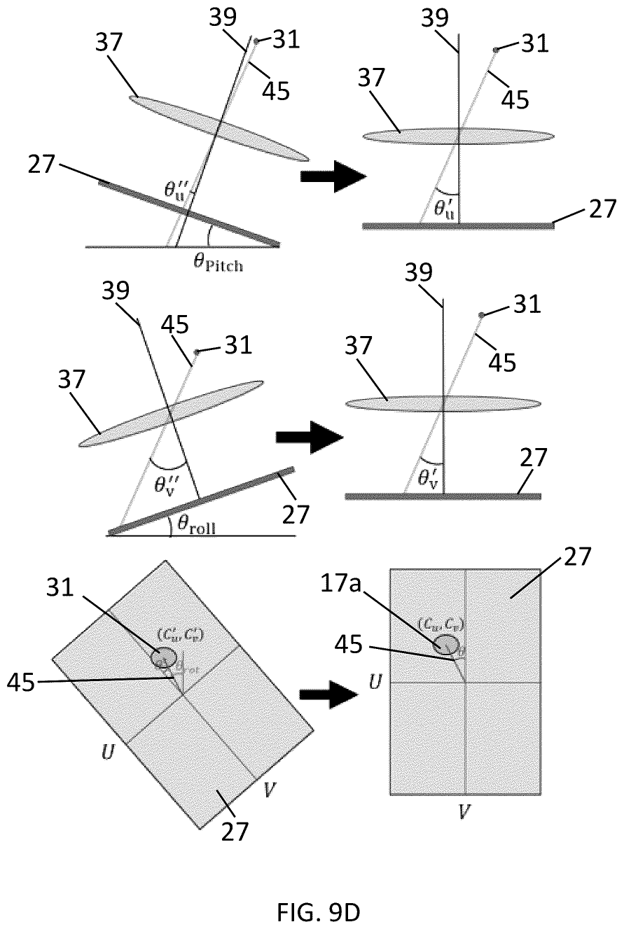

One possible process 304 of determining the bearing of the device 3 from the light source 17a-f will now be discussed, with reference to FIGS. 8 to 9.

In a first step 352, once the light source 17a is detected, the centre of the mass 31 of the light source is determined as (Cᵤ″, Cᵥ″).

FIG. 9A shows a schematic of the image plane 27, with the axis 29 in the vertical direction v, and the axis 31 in the horizontal direction u shown by short dashed lines. These axes define the image plane 27.

Within the image is the area 33 identified as the outline of the light source. The centre of mass 31 is determined as the centre point of this (based on a balancing point assuming a sheet of material with uniform density).

In a second step 354, the angle of incidence is determined based on the centre of the mass of the light source and the field of view (θ_{Fov}) of the camera:

$${θ}_{v}^{″} = - {tan}^{- 1} ( ( \frac{2 {C}_{v}^{″}}{V} - 1 ) tan ( \frac{{θ}_{F o V , v}}{2} ) )$$

$${θ}_{u}^{″} = - {tan}^{- 1} ( ( \frac{2 {C}_{u}^{″}}{U} - 1 ) tan ( \frac{{θ}_{F o V , u}}{2} ) )$$

It will be appreciated that the orientation (pose) of the device 3 and hence camera 7 will influence the angle of incidence determination. The pose of the device 3 can be described by three angles of rotation, around three perpendicular axes defined by the plane 27 of the camrea7/image 21. The roll (θᵣₒₗₗ) is the rotation around the axes perpendicular to the plane 27 of the image 21, the yaw (θ_{yaw}) is the rotation around a vertical axis 29 of the plane 27 of the image 21, and the pitch (θ_{pitch}) is the rotation around the non-vertical axis 31 defining the image plane 27.

FIG. 9B shows the angular system from top down view and FIG. 9C shows the system from side on view. FIGS. 9B and 9C show the image plane 27 (formed at the plane of the detector of the camera 7) and the lens 37 of the camera 7. As shown in FIG. 9C, the light emitted from the light source 17a forms a cone of angle θₜₓ. FIG. 9B shows the azimuthal angle θ_{az} of the camera relative to a nominal origin 40 (vertically down from the centre of mass) and FIG. 9C shows the angle of arrival of the light θ_{rx,z} FIGS. 9B and 9C illustrate a normal 39 extending perpendicular to the image plane 27, around which the yaw and pitch are measured and the bearing 45 from the centre of the light source 17a through the centre of the lens 37.

The nominal origin has position x=x_{light}, y=y_{light}, Z=0 (defined relative to a floor 42).

In steps 356a, 356b, 356c, the angles are mapped to co-ordinates where the roll, pitch and yaw are all 0 according to the below.

From mapping to roll=0 (step 356a):

$${θ}_{v}^{′} = {θ}_{v}^{″} + {θ}_{roll}$$

$${C}_{v}^{′} = \frac{V}{2} \times \frac{tan ( {θ}_{v}^{′} )}{tan ( \frac{{θ}_{FoV , v}}{2} )}$$

For mapping to pitch=0 (step 356b):

$${θ}_{u}^{′} = {θ}_{u}^{″} - {θ}_{p i t c h}$$

$${C}_{u}^{′} = \frac{U}{2} \times \frac{tan ( {θ}_{u}^{′} )}{tan ( \frac{{θ}_{FoV , u}}{2} )}$$

For mapping to yaw=0 (step 356c):

$${r}^{′} = \sqrt{{( {C}_{u}^{′} )}^{2} + {( {C}_{v}^{′} )}^{2}}$$

$${θ}^{′} = atan ( \frac{{C}_{u}^{′}}{{C}_{v}^{′}} )$$

FIG. 9D shows the representation of (top) the transformation for pitch, (middle) the transformation for roll and (bottom) the transformation for yaw, showing the normal 39 of the image plane 27 and the bearing 45 from the light source to the lens 37. From the above, it can be seen that:

$$\{ \begin{matrix}0 \leq {θ}^{′} < 90 , & {C}_{u}^{′} \leq 0 , {C}_{v}^{′} > 0 \\ 90 \leq {θ}^{′} < 180 , & {C}_{u}^{′} < 0 , {C}_{v}^{′} \leq 0 \\ 1 \; 80 \leq {θ}^{′} < 270 , & {C}_{u}^{′} \geq 0 , {C}_{v}^{′} < 0 \\ 2 \; 70 \leq {θ}^{′} < 360 , & {C}_{u}^{′} > 0 , {C}_{v}^{′} \geq 0\end{matrix}$$

$$θ = {θ}^{′} + {θ}_{r o t}$$

$${C}_{u} = {r}^{′} sin ( θ )$$

$${C}_{v} = {r}^{′} cos ( θ )$$

In the next step 358, the angle of departure of light leaving the light source 17a-f (considered to be the centre of mass of the light source 17a-f) and arriving at the centre of the camera 7 can be found as:

$${θ}_{r x , y} = {tan}^{- 1} ( \frac{2 {C}_{u}}{U} tan ( \frac{{θ}_{F o V , u}}{2} ) )$$

$${θ}_{r x , x} = {tan}^{- 1} \frac{2 {C}_{v}}{V} tan ( \frac{{θ}_{F o V , v}}{2} ) )$$

Based on the angles of departure θ_{rx,y} and θ_{rx,x}, the height of the phone h, which is determined as discussed above, and the height of the light source H, which is retrieved form the lookup tables 120, the relative position of the device 3 can be found as shown below, in step 360:

$$x = ( H - h ) tan ( {θ}_{r x , x} )$$

$$y = ( H - h ) tan ( {θ}_{rx , y} )$$

H and h are determined relative to the nominal floor 42.

In the above examples, the footprint 19a-f form light sources 17a-f that encode unique identifiers ID1, ID2, ID3 do not overlap. Thus encoding systems such as Manchester encoding may be used. In other examples, the footprint 19a-f form light sources 17a-f that encode unique identifiers may overlap. In this case, the light sources 17a-f shown in FIG. 1 may each have a unique identifier ID1, ID2, ID3, ID4, ID5, ID6.

Referring to FIG. 1, where outputs 19a-f form light sources 17a-f that encode unique identifiers ID1, ID2, ID3 do overlap, there will be regions 27a-g where the output 19a-f from two light sources 17a-f interfere. In the presence of interference, the different unique identifiers ID1, ID2, ID3, ID4, ID5, ID6 can be extracted by using an orthogonal coding system, such as Code division multiple access (CDMA), instead of Manchester encoding.

In examples where CDMA is used, each light source 17a-f has an associated unique identifier having a number of bits. In CDMA, the unique identifier ID1, ID2, ID3, ID4, ID5, ID6 is encoded my multiplying each bit of the unique identifier ID1, ID2, ID3, ID4, ID5, ID6 by a unique Walsh code with n_{chips} number of chips per code.

Each Walsh code is represented by a number of chips, such as, for example {1, −1, −1, 1}, {1, 1, −1, −1}, {1, 1, 1, 1}, or {1, −1, 1, −1}, where each code contains four chips of 0 s and 1 s. These codes are multiplied by each bit in the modulation and the output is modulated and transmitted through the channel. In these examples, then length of the Walsh codes is 4 bits, but the Walsh code can have length 2^{N}, where N is any integer.

n_{chips} is fixed for all codes and is set by the number of interfering sources. Only codes with average energy=0 (i.e. the sum of the Walsh codes is 0) are used, to ensure no flickering in the light sources 17a-f. For example, {1, −1, −1, 1}, {1, 1, −1, −1}, or {1, −1, 1, −1} may be used but not {1, 1, 1, 1}. Therefore, the number of available Walsh codes is n_{chips}−1.

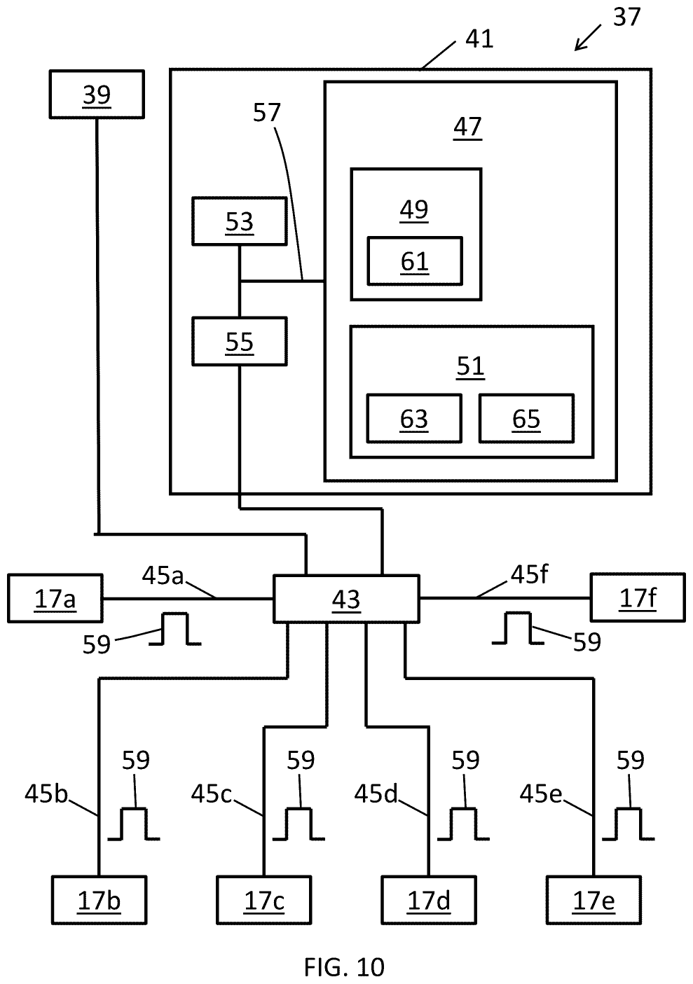

FIG. 10 illustrates a lighting system 37 used to illuminate the indoor space 9 shown in FIG. 1. Power is provided form a power source 39. A control unit 41, which controls a system driver 43 are also provided. It will be appreciated that various modules, such as voltage protection, noise filtering, rectification, power factor correction and isolation modules may be provided between the power 39 and driver 43. These are not shown for clarity.

The system driver 43 is connected to light sources 17a-f, which can be any type of light fixture that provides visible light for illuminating an area. Each light source is connected on a separate channel 45a-f of the driver 43. The control unit 41 controls the driver 43 to modulate the output signal sent to each light source 17a-f to include the unique identifier ID1, ID2, ID3, ID4, ID5, ID6.

It will be appreciated that the driver 43 also controls other properties of the light output and lighting system, such as, but not limited to, the intensity and colour of the light.

As shown in FIG. 10, the system control unit 41 includes a memory 47 that has a program storage portion 49 and a data storage portion 51. The control unit 41 further includes a suitable microprocessor 53 in communication with the memory 47, and a communications interface 55 in communication with the driver 43. The memory 47, microprocessor 53 and communications interface 55 are all connected through a system bus 57.

The program storage portion 49 of the memory 47 contains program code including instructions that when executed on the microprocessor 53 instruct the microprocessor 53 what steps to perform. The program code may be delivered to memory 47 in any suitable manner. For example, the program code may be installed on the device from a CDROM; a DVD ROM/RAM (including −R/−RW or +R/+RW); a separate hard drive; a memory (including a USB drive; an SD card; a compact flash card or the like); a transmitted signal (including an Internet download, ftp file transfer of the like); a wire; etc.

The microprocessor 53 may be any suitable controller, for example an Intel® X86 processor such as an 15, 17, 19 processor or the like.

The memory 47 could be provided by a variety of devices. For example, the memory 47 may be provided by a cache memory, a RAM memory, a local mass storage device such as the hard disk, any of these connected to the microprocessor 53 over a network connection. The microprocessor 53 can access the memory 47 via the system bus 57 and, if necessary, through the communications interface 55 such as WiFi, 4G and the like, to access program code to instruct it what steps to perform and also to access data to be processed.

It will be appreciated that although the microprocessor 53 and memory 47 have been described as single units, the functions of these elements may be distributed across a number of different devices or units. Furthermore, the processing steps discussed below may all be performed at the same locations or two or more different locations.

The program storage 49 of the memory 47 include a CDMA encoding module 61 that encodes unique identifiers ID1, ID2, ID3, ID4, ID5, ID6 using Walsh codes. The unique identifiers ID1, ID2, ID3, ID4, ID5, ID6 and Walsh codes are stored in corresponding sections 63, 65 of the data storage 51 of the memory 47. The control unit 41 then ensures that the driver modulates the output of each channel 45a-f with the appropriate encoded unique identifier.

In addition, the control unit 33 controls the driver 43 to send a synchronisation pulse 59 to each light source 17a-f. The synchronisation pulse 59 ensures that each light source 17a-f emits the corresponding encoded unique ID at the same time (within 2 ms).

Where the unique identifier ID1, ID2, ID3, ID4, ID5, ID6 is encoded by CDMA, the processes for detecting and extracting the identifier is the same as discussed above. However, CDMA decoding is used instead of Manchester decoding.

The use of CDMA also allows pattern decomposition of the illuminated footprint of the light sources 17a-f. This allows decomposing individual non-line-of-sight (NLOS) footprints of the lights in the presence of interference. This is done by selecting small regions in the image and processing each region as discussed above. The contrast of the output intensity of the bits is measured and reported as the intensity of the code in each region.

After processing a number of small regions, n_{chips}−1 individual patterns are obtained. The pattern decomposition can be used as supplementary information in the method 300 of FIG. 7, to help estimate the position of the device 3 relative to the light sources 17 from the reflections. This is achieved using Machine Learning algorithms.

The pattern recognition also allows implementing zero-forcing equalisers to extract the unique identifiers ID1, ID2, ID3, ID4, ID5, ID6 from the image 21 even if the CDMA code is removed temporarily.

In some examples where the unique identifiers ID1, ID2, ID3, ID4, ID5, ID6 are encoded by CDMA, this may be used in combination with Spatial Division Multiple Access (SDMA) decoding to determine the position of the device, based on the footprint of one or two light sources 17a-f reflected from a surface. In general, it is more likely for there to be two reflections in an image 21 than two light sources 17a-f in direct line of sight. This is because the distance between the reflected footprint of the light sources 17a-f is half the distance between the light sources 17a-f.

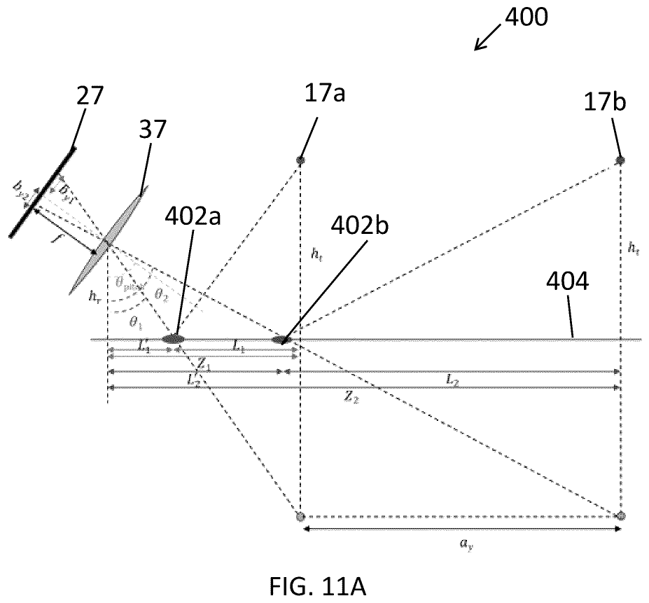

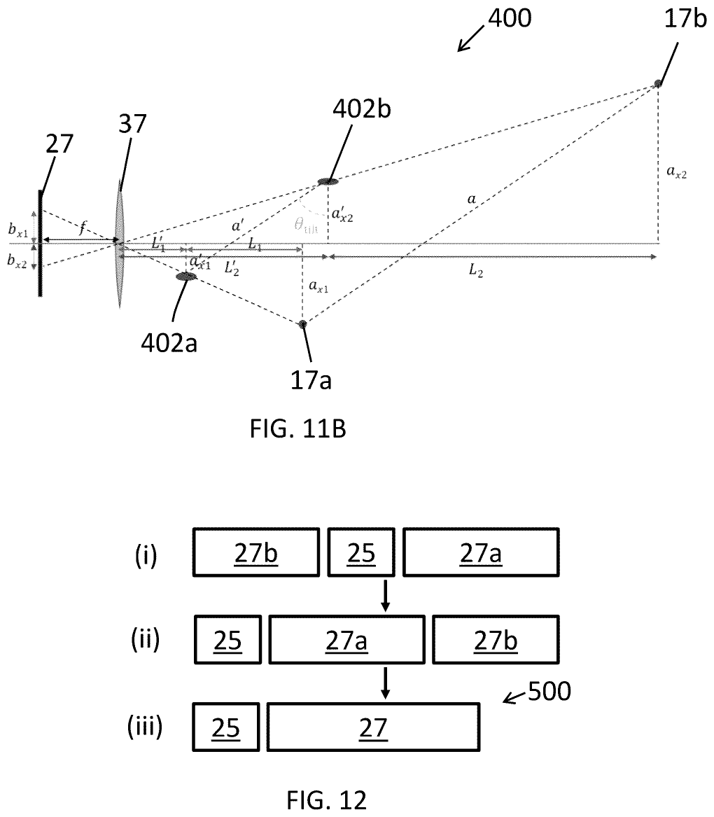

FIGS. 12A and 12B schematically illustrates a system 400 in which reflections 402a,b of two light sources 17a,b are visible on a reflective surface 404, such as the floor. FIG. 11A shows a side on view, and FIG. 11B shows a plan view. As shown in FIG. 11A, the image plane 27 and camera lens 37 are positioned such that the light sources 17a-f are not in direct line of sight of the camera 7, but the reflections 402a, 402b are visible in the image 21. Reflections 402a, 402b on any suitable reflecting surface may be used. For example, the surface may be (e.g., stone, timber, vinyl, and laminate flooring).

To perform SDMA, the brightest areas of the image 21 are identified. Around the identified areas, CDMA pattern decomposition is performed to extract the unique identifiers ID1, ID2, ID3, ID4, ID5, ID6 and to ensure the spot is related to the reflection of a light source 17a-f.

The distance between the device 3, and a first light source 17a in x and z directions (aₓ₁ and z₁), the height of the device 3 (hᵣ) and the tilting angle of the camera (θₜᵢₗₜ) can, all measured to the centre point of the lens 37 are obtained as follows:

$${Z}_{1} = \frac{af {χ}_{1}}{\sqrt{{f}^{2} {( {χ}_{2} - {χ}_{1} )}^{2} + {( {χ}_{1} {b}_{x 1} + {χ}_{2} {b}_{x 2} )}^{2}}} ,$$

$${a}_{x 1} = \frac{a {b}_{x 1} {χ}_{1}}{\sqrt{{{f}^{2} ( {χ}_{2} - {χ}_{1} )}^{2} + {( {χ}_{1} {b}_{x 1} + {χ}_{2} {b}_{x 2} )}^{2}}} ,$$

$${h}_{r} = \frac{a f}{\sqrt{{{f}^{2} ( {χ}_{2} - {χ}_{1} )}^{2} + {( {χ}_{1} {b}_{x 1} + {χ}_{2} {b}_{x 2} )}^{2}}} ,$$

$${θ}_{tilt} = {sin}^{- 1} ( \frac{f ( {χ}_{2} - {χ}_{1} )}{\sqrt{{{f}^{2} ( {χ}_{2} - {χ}_{1} )}^{2} + {( {χ}_{1} {b}_{x 1} + {χ}_{2} {b}_{x 2} )}^{2}}} )$$

$$where$$

$${χ}_{1} = tan ( {θ}_{p i t c h} + {tan}^{- 1} ( \frac{{b}_{y 1}}{f} ) ) and {χ}_{2} = tan ( {θ}_{p i t c h} + {tan}^{- 1} ( \frac{{b}_{y 2}}{f} ) ) .$$

As shown in FIGS. 12A and 12B:
a is the distance between the light sources, which is known;
f is the focal length of the camera 7 i.e. the distance from the image plane 27 to the lens 37;
bₓ₁ is the distance between the centre point of the image plane 27 and the reflection 402a of the first light source 17a in the x direction, in the detected image 21.
bₓ₂ is the distance between the centre point of the image plane 27 and the reflection 402b of the second light source 17b in the x direction, in the detected image 21.
b_{y1} is the distance between the centre point of the image plane 27 and the reflection 402a of the first light source 17a in the y direction, in the detected image 21.
b_{y2} is the distance between the centre point of the image plane 27 and the reflection 402b of the second light source 17b in the y direction, in the detected image 21.

In the above methods, it is assumed that each image 21 contains a full contiguous VLC packet. In other words, it is assumed that each image includes at least one header 25 with a subsequent complete payload 27. Due to the roller shutter effect, the position of the header(s) 25 will change from image to image.

In one example, the positioning method 300 may only be performed on images a complete VLC packet. However, this results in multiple images/frames being wasted, which in turn would mean longer times between determinations of the position and unnecessary computing and battery usage.

In other examples, by knowing the position of the header 25, it is possible to construct the packet even if a full contiguous VLC packet is visible or not, using the areas before and after the header 25.

FIG. 12 schematically illustrates how a VLC data packet 500 can be constructed from an image without a complete payload region 25.

As shown in step (i) of FIG. 12, the image may include a header 25 of a data packet 500. Partial payload regions 27a, 27b may be provided in front of and behind the header 25. However, the image does not include a complete packet 500 of a header 25 and a payload 27 following the header 25.

In step (ii) of FIG. 12, the partial payload regions 27a, 27b are rearranged such that they are both behind the header 25. The overlap between the tail end of the partial payload region 27a from behind the header 25 and the front end of the partial payload region in front of the header is then determined, to allow the full payload region to be reconstructed, as shown in (iii).

An alternative way to visualise the reconstruction of a VLC packet 500 is to assume a packet 500 with a payload region have 8 bits b₀ to b₇. The image captures the following:

| | | | | | | | | | | |
|---|---|---|---|---|---|---|---|---|---|---|
| b₄ | b₅ | b₆ | b₇ | HEADER | b₀ | b₁ | b₂ | b₃ | b₄ | b₅ |

By considering the overlap of b₄, and b₅, the full payload 27 can be constructed:

| | | | | | | | |
|---|---|---|---|---|---|---|---|
| HEADER | b₁ | b₂ | b₃ | b₄ | b₅ | b₆ | b₇ |

The method of packet reconstructions still requires sufficient bits to construct the full payload 27, even if they are not in order. If there are not enough bits available in a particular image, the data from the partial payload regions 27a, 27b is saved in device memory 104. Each partial payload region 27a, 27b, both before and after the header 25, is checked against all other seen partial payload regions 27a, 27b identified, to reduce the probability of errors. This process is continued with subsequent images/frames until such time that the total number of bits meets the required amount. Once this amount is reached, the partial payload regions 27a, 27b with the largest number of bits from both before and after header 25 are combined them to make a full VLC data packet.

By plotting the position of the device 3 over time, a trajectory of the user can be determined, and a future trajectory predicted. As discussed above, the location of light sources 17a-f within an area may be known. The locations of other landmarks may also be known. In some embodiments, the system may determine what landmarks are within a specified distance of the user and then filter those results to predict what landmarks should be visible to the user along their predicted trajectory.

Knowing when the user steps from information from the step counter 122, and the users step size, from the gait prediction, the system can further calculate the predicted number of steps and time taken for a landmark to become visible to the user. This can then be used as a secondary check for positioning, by analysing images to determine if the object is seen. This can also be used to help reduce power consumption on the device 7 by turning on/off sensors/cameras. For example, if no light sources or optical beacons are along the user's current trajectory then the camera 7 may be turned off until one is predicted nearby.

In the examples discussed above, the device 3 that is positioned is a unit such as a mobile phone having a camera 7. It will be appreciated that any device having a camera 7 and suitable sensors for providing required supplementary information can be positioned by the methods discussed above.

In further examples, any suitable photosensitive device/light detector may be used instead of a camera. For example, photodiodes may be used to detect the light output from the light sources 17a-f, decode the unique identifiers ID1, ID2, ID3, ID4, ID5, ID6 and determine the position of the device 3. In this case, rather than use an image or frame, the signal processed may be a snapshot detected in a window (the length of the window corresponding to the exposure time of the camera 7).

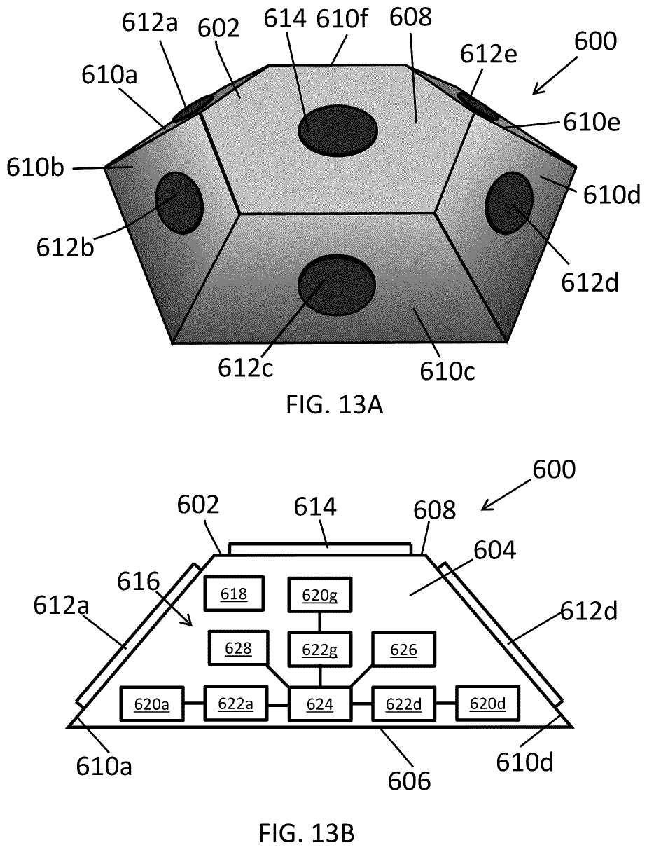

FIGS. 13A and 13B illustrate one example of a device which can be positioned according to the above methods. The device is in the form of an optical tag 600 that can be fixed to or carried by or with objects or people, or placed in specific locations. FIG. 13A shows the tag 600 in perspective view and FIG. 13B shows the tag in cut-through side view.

The tag 600 is formed of a body 602 defining an enclosed space 604 inside. The body has a flat hexagonal base 606 and a parallel hexagonal top 608 spaced above the base 606. The top 608 is positioned centrally with respect to the base 608, and when viewed from above, each of the sides of the top 608 is parallel to a corresponding side of the base 606. The top 608 is smaller than the base 606. Therefore, the body 602 includes six sidewalls 610a-f that are trapezoidal in shape, and inclined inwards from the base 606 to the top 608.

A photodiode detector 612a-f is provided on each of the sidewalls 610a-f, and a solar cell 614 is provided on the top 608, and the control system 616 of the tag 600 is housed in the enclosed space 604 inside the body.

The control system 616 is shown in more detail in FIG. 13B. The control system 616 includes a battery 618 that is charged by the solar cell 614. The output from each photodiode 612a-f is passed through a corresponding trans-impedance amplifier 620d and an analogue-to-digital-converter 622a-f. Likewise, the output from the solar cell, 614 is also passed through a trans-impedance amplifier 620g and analogue-to-digital-converter 622g.

The outputs from the analogue-to-digital-converters 622a-g are provided to a processing system 624, which may be arranged to operate in a similar manner to the processing system 100 discussed above.

The outputs from each of the photodiodes 612a-f and solar cell 614 is analysed to extract one or more unique identifier(s) from light source 17a-f which illuminate the tag 600. Furthermore, the output is analysed to identify relative signal strength information (RSS).

Since the orientation of each sidewall 610a-f and the top 608 is known, the RSS allows the angle of arrival of light falling on the different photodiodes 612a-f. Together with the pitch, and roll data obtained by an accelerometer 626 provided in the tag can give a precise positioning accuracy using the methods discussed above by mapping the detected bearing to the frame where to roll, pitch and yaw are all 0, in a similar manner to discussed above.

In case the tag 600 does not have line of sight to at least one light source 17a-f, the tag 600 also includes communication interfaces 628, such as WiFi and/or Bluetooth to allow for positioning relative to signal emitting beacons (not shown). The communication interfaces 628 also allow the tag to communicate its determined position to an external server (not shown) where it can be accessed.

In one embodiment, the tag 600 is approximately 3 to 5 cm across at the base 606, and approximately 2 to 4 cm high. This makes it easy for the tag to be fixed to an item or to the clothing of a user to allow the item or user to be tracked.

In some of the method discussed above, the camera 7 of a mobile phone is used. It will be appreciated that devices such as mobile phones may have more than one camera 7. For example, a mobile phone may have at least a front facing camera and a rear facing camera. The methods discussed above are capable of using outputs from any camera 7 of a mobile phone. In some examples, where a device 3 includes multiple camera 7, the method may cycle through the output of each camera in turn to determine the presence of a unique identifier ID1, ID2, ID3, ID4, ID5, ID6 encoded in VLC data, and a light source 17a-f or possibly reflection 402a, 402b in the image 21. Alternatively, the method may only use a limited subset comprising one or more of the camera(s) 7. This may be determined by the method or set by a user.

The unique identifier ID1, ID2, ID3, ID4, ID5, ID6 may be modulated onto the output of the light sources using a variety of suitable modulation schemes. This may include, by way of example only, pulse amplitude modulation (PAM), pulse position modulation (PPM), pulse number modulation (PNM), pulse width modulation (PWM), pulse density modulation (PDM), quadrature amplitude modulation (QAM), or phase or frequency based modulation.

Where amplitude modulation is used, the amplitude depth may be varied with the overall light output of the light source 17a-f, such that the position of the device may be determined, even with dimmed light sources.

In the examples discussed above, Manchester encoding and CDMA encoding using Walsh codes are used for encoding and decoding the unique identifiers. It will be appreciated that this is by way of example only, and any suitable encoding and decoding scheme may be used.

In the presence of interference in VLC encoded outputs, an encoding system having orthogonal codes should be used to encode the light sources 17a-f which have outputs overlapping. In the above example, CDMA is used. This may include CDMA schemes such as (but not limited to): wideband CDMA (W-CDMA); time-division CDMA (TD-CDMA); time-division synchronous CDMA (TD-SCDMA); direct-sequence CDMA (DS-CDMA); frequency-hopping CDMA (FH-CDMA)1 or multi-carrier CDMA (MC-CDMA). In other examples, other orthogonal encoding systems will also be suitable. Alternative orthogonal encoding systems may include, by way of non-limiting example: orthogonal frequency-division multiple, OFDM; orthogonal frequency-division multiple access, OFDMA; wavelength division multiple access (WDMA); carrier-sense multiple access with collision avoidance (CSMA/CA); ALOHA; slotted ALOHA; reservation ALOHA; R-ALOHA; mobile slotted ALOHA, MS-ALOHA or any other similar system.

It will be appreciated that where a system includes a large number of light sources 17a-f, some of which overlap and some of which do not, the same codeword may be used for non-overlapping light sources.

It will be appreciated that the header 25 or payload 27 of the VLC data packet 500 may include information on the code used in the encoding system to allow for easier decoding and use of shorter unique identifiers. Furthermore, in some examples, the unique identifier is generated by combination of a light source identifier (which may not be unique) and a code. The combination results in a unique identifier.

The header 25 of the data packet 500 may have any suitable structure that allows it to be identified in the image 21. The structure of [1,1,1,1,0,0,0,0] discussed above is given by way of example only.

In the method to extract a unique identifier ID1, ID2, ID3, ID4, ID5, ID6 from an image 21, separate correlation steps are used for coarse identification of the header and fine identification. In other examples, only a single correlation step may be used, omitting the fine correlation step. Alternatively, three or more correlation steps, each time narrowing in on identified possible headers, may be used.

FIG. 3 illustrates an example of a processing system 100 for determining the position of the device 3 or tag 600. As discussed above, the operation of the processing system 100 may be distributed across a number of units or locations. In some examples, the device 3 itself may perform part or all of the processing. In other examples, the device may transmit images and other sensor data to a remote location(s) for processing. The determined position may then be transmitted back to the device 3 and/or to other locations. In particular, for embodiments using the tag 600, it is useful for the location to be transmitted to an asset/user tracking system (not shown)

FIG. 10 illustrates an example of a lighting system with a control unit 41 controlling operation of the system. It will be appreciated that the lighting system control unit 41 may also implement some or all of the function of the processing system 100 used to determine the position of a device 3 or tag 600. In particular, the data storage portion 51 of the memory 47 of the lighting system control unit 41 may include lookup tables for the position of light sources 17a-f and other landmarks. The lookup table may be any suitable building inventory management (BIM) system.

The tag 600 shown in FIGS. 14 and 15 is given by way of example only. The tag may have any suitable shape and size, and may have any number of faces, detectors, 612 and solar cells 614.

Any apparatus equipped with one or more suitable light sensors may be positioned using the above method. In the examples give above, the sensors include cameras 7, photodiodes 612a-f and solar cells 614, however any other type of sensor that detects the modulation of the unique identifier ID1, ID2, ID3, ID4, ID5, ID6 on the light output may be used.

In the above example, VLC based positioning is achieved by having fixed light source(s) with associated unique identifier(s) and sensors having variable position. On other examples, this may be the other way round. The device with a unique identifier may have a light source which transmits the identifier as VLC encoded data. This may be detected by sensors located around an area to position device, possibly in combination with other sensor information from the device).

Where the method of positioning a device is performed on a mobile phone, it may be carried out on a mobile phone application that is run in the foreground and/or background of the mobile phone operating system.

FIG. 1 shows a simple example of a single area having six light sources 17a-f. It will be appreciated that this is by way of example only. The system may be implemented in buildings or areas of any size and configuration. Some or all of the light sources 17a-f may be external as well as internal.

In the above, VLC will be described with reference to transmitting a unique identifier of a light source, to enable a device that detects the light to position itself. However, it will be appreciated that this is by way of example only. The described techniques can be applied to any form of VLC, transmitting any form of data, where the unique identifier is replaced with the data to be transmitted. Where any decoding may be stopped until a change of condition (such as movement of the device) is detected that might indicate data is now available.

In the above, the light transmitted by the light fixtures 17a-f is in the visible range. However, it will be appreciated that this is by way of example only. In other examples, the light emitted by be used to illuminate an area with visible or non-visible light (such as infrared or ultraviolet). Whilst the communication method is referred to as visible light communications (VLC) it will be appreciated that this also encompasses non-visible light outputs.

What is claimed is:

1.-25. (canceled)

26. A method of decoding a detected light signal to extract data transmitted via light based communications, the method comprising:
receiving a detected light signal having a plurality of signal features corresponding to bits of at least part of a transmitted data packet;
identifying a location of at least one first region of the detected signal corresponding to a header of a data packet;
identifying a location of at least one second region of the detected signal corresponding to a payload of the data packet, based on the position of the at least one first region; and
decoding the signal features in the at least one second region to derive a string of data.

27. A method as claimed in claim 1, wherein:
the detected light signal is light from an artificial light source intended for illumination of an area;
the signal features are encoded as modulations on a light output of the artificial light source; and
the modulations are not perceptible to a user.

28. A method as claimed in claim 1, wherein:
at least two first regions corresponding to headers of the data packet are identified, and wherein a second region is identified as the portion of the signal between two first regions; or
a single header region is identified in detected signal, the method further comprising:
identifying a first portion of the payload before the header;
identifying a second portion of the payload after the header;
constructing the data packet by combining the first and second portions of the payload, based on an overlap of the first and second portions.

29. A method as claimed in claim 3, when a header region is identified in detected signal, the method further comprising:
receiving a sequence of detected signals;
identifying a plurality of portions of the payload before and after the header, over the sequence of detected signals;
constructing the data packet by combining at least two portions of the payload from different frames or windows, based on an overlap of the at least two portions.

30. A method as claimed in claim 1, wherein the detected signal is detected in a capture window, and wherein the length of the capture window is less than the period of the pulse used to modulate the data onto the light signal.

31. A method as claimed in claim 1, wherein identifying the location of the at least one first region of the detected signal comprises:
generating a predicted version of the header; and
correlating the detected signal with the predicted version of the header, wherein the at least one first region is identified as a region with high correlation.

32. A method as claimed in claim 6, wherein the predicted version of the header is generated using a sampling rate of a detector that has detected the signal and a known structure of the header.

33. A method as claimed in claim 7, wherein:
the sampling rate is estimated based on a known number of bits in the header and the measured width of a feature estimated to be the header in the detected signal; and
the feature estimated to be the header is determined by: applying a zero-crossing algorithm to the detected signal to identify all edges in the signal;
and estimating a feature to be the header based on the known structure of the header and the identified edges.

34. A method as claimed in claim 8, comprising:
determining a coarse position of the header by performing a correlation using the predicted version of the header and the detected signal; and
determining a fine position of the header by performing a correlation using an upsampled version of the detected signal and the predicted version of the header.

35. A method as claimed in claim 9, wherein the step of determining a fine position is only performed in the vicinity of positions in regions identified in the step of determining a coarse position.

36. A method as claimed in claim 1, wherein the detected light signal includes a plurality of channels, and the method comprises:
selecting only a single channel to use as the detected signal.

37. A method as claimed in claim 1, comprising:
analysing the detected signal for the presence of encoded data;
if encoded data is present, continuing the method; and
if encoded data is not present, stopping the method.

38. A method as claimed in claim 1, wherein the detected signal is captured by a photosensitive device, and the data is modulated as different intensity levels on the signal.

39. A method as claimed in claim 1, wherein:
the detected signal includes light from at least two sources, there being interference between the output of the light sources; and
the data is encoded using an orthogonal encoding system.

40. A method as claimed in claim 14, wherein the orthogonal encoding system is selected from at least: code divisional multiple access, CDMA; orthogonal frequency-division multiple, OFDM; orthogonal frequency-division multiple access, OFDMA; wavelength division multiple access, WDMA; carrier-sense multiple access with collision avoidance, CSMA/CA; ALOHA; slotted ALOHA; reservation ALOHA; R-ALOHA; mobile slotted ALOHA, MS-ALOHA, wherein spatial division multiple access, SDMA, decoding is used in combination with CDMA to determine the position of the device based on the detection of reflections of multiple light sources.

41. A method as claimed claim 1, wherein the data comprises a unique identifier of a light source emitting the light captured in the detected signal, the method further comprising:
receiving position data indicating a location of the light source in a global co-ordinate system; and
determining a position of the device, wherein the determination of the position is based, at least in part on, the position data of the artificial light source.

42. A lighting system comprising:
one or more light sources;
one or more drivers, the one or more drivers arranged to modulate the output of the light sources to encode data on the output of the light source as light based communications, the data including a data packet having a header of known structure, and a payload.

43. A lighting system as claimed in claim 17, wherein:
the output from at least some of the light sources overlap;
the data is encoded using an orthogonal encoding system; and
the one or more drivers are arranged to synchronise the output of the light sources.

44. A lighting system as claimed in claim 17, wherein the period of the pulse used to modulate the data onto the light emitted by the source is longer than a window in which the data is captured; and wherein the modulation depth of the data is variable in dependence on the total light output.

45. A computer program that, when read by a computer, causes performance of the method of claim 1.

46. A lighting system as claimed in claim 17, wherein a computer program is read by a computer to operate the lighting system.
